(19) United States
(12) Patent Application Publication
(10) Pub. No.: US 2010/0328365 A1
(43) Pub. Date: Dec. 30, 2010

(54) SEMICONDUCTOR DEVICE

(75) Inventors: Kouji Ikeda, Chiba-shi (JP); Masami Iseki, Mobara-shi (JP); Fujio Kawano, Kawasaki-shi (JP); Hiroyuki Maru, Kawasaki-shi (JP); Tatsuhito Goden, Chiba-shi (JP); Takanori Yamashita, Chiba-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/795,137

(22) Filed: Jun. 7, 2010

(30) Foreign Application Priority Data
Jun. 30, 2009 (JP) 2009-154728

(51) Int. Cl. G09G 5/10

(52) U.S. Cl. 345/690

(57) ABSTRACT

A display apparatus includes: a light emitting element, a source which supplies a current to the light emitting element from a drain; a capacitor one end of which is connected to a gate of the transistor; a gate voltage setting circuit detachably connected to the gate of the transistor, the gate voltage setting circuit setting the gate voltage of the transistor to an initial voltage; and a capacitor terminal voltage setting circuit which is connected to another end of the capacitor, and which sets the voltage of the another end of the capacitor to any of data voltage corresponding to image information and constant reference voltage which does not depend on the image information, wherein a range, in which a current flowing through the light emitting element varies depending on the data voltage, is adjusted by changing one of the initial voltage and the reference voltage.

### BACKGROUND OF THE INVENTION

1. Field of the Invention

The present invention relates to a display apparatus having self-luminous elements, particularly organic EL elements, arranged in a matrix, and a method of driving the same.

2. Description of the Related Art

A self-luminous display apparatus represented by an organic EL is configured by arranging a plurality of pixels including self-luminous elements in a matrix on a substrate. In a driver circuit of the self-luminous display apparatus, in order to precisely apply gradation to each pixel, the amount of a current flowing through or the voltage applied to a self-luminous element of each pixel has to be precisely controlled. Usually, the self-luminous display apparatus has an active-matrix configuration, wherein a switching element such as a thin film transistor (TFT) (an active element, hereinafter referred to as a TFT) is provided for each pixel.

In the field of such a display apparatus with an active matrix configuration, a technique is known, wherein the current or the voltage applied to a display element is controlled according to the average luminance of a display image so as to improve the display quality of the display apparatus. Japanese Patent Application Laid-Open No. 2008-015516 proposes a method of changing the display luminance as a whole by changing stepwise a gamma reference voltage according to the average luminance of a display image and thereby reducing damage on a self-luminous element and a TFT for driving the same.

In the conventional display apparatus, an analog data voltage converted based on a gamma reference voltage is output from a data driving unit and programmed onto a data line, and therefore when the maximum luminance of an organic EL element is increased, the analog data voltage also increases. This results in a problem that the amplitude of the analog data voltage increases and the power consumption of a block for outputting the analog data voltage, particularly the power consumption in a voltage output amplifier unit, increases. Furthermore, if the amplitude of the analog data voltage increases, the withstanding voltage of the data driving unit needs to be increased and thus requires a high voltage process, which leads to an increase in cost.

### SUMMARY OF THE INVENTION

The present invention provides a display apparatus configured to increase the maximum luminance of a light emitting element without increasing the voltage amplitude of a data line voltage driving unit.

According to an aspect of the present invention, a display apparatus includes: a plurality of pixels arranged two-dimensionally, wherein each of the pixels has a light emitting element, a transistor which controls a current supplied to the light emitting element, and a capacitor of which one end is connected to a gate of the transistor; a gate voltage setting circuit capable to connect to the gate of the transistor, the gate voltage setting circuit applying an initial voltage to the gate of the transistor in connecting; a capacitor terminal voltage setting circuit which is connected to another end of the capacitor, and which applies any of data voltage corresponding to image information and constant reference voltage which does not depend on the image information to the another end of the capacitor; and a control circuit which controls the gate voltage setting circuit and the capacitor terminal voltage setting circuit, wherein the control circuit applies the initial voltage to the gate of the transistor by the gate voltage setting circuit, and applies either one voltage of the data voltage corresponding to the image information or the constant reference voltage which does not depend on the image information by the capacitor terminal voltage setting circuit, and then switches the one voltage which the capacitor terminal voltage setting circuit has applied, to another voltage of the data voltage corresponding to the image information or the constant reference voltage which does not depend on the image information, with the gate voltage setting circuit not connecting to the gate of the transistor.

Moreover, according to another aspect of the present invention, a method of driving a display apparatus, the display apparatus including: a plurality of pixels arranged two-dimensionally, wherein each of the pixels has a light emitting element, a transistor which controls a current supplied to the light emitting element, and a capacitor of which one end is connected to a gate of the transistor; a gate voltage setting circuit capable to connect to the gate of the transistor, the gate voltage setting circuit applying an initial voltage to the gate of the transistor in connecting; and a capacitor terminal voltage setting circuit which is connected to another end of the capacitor, and which applies any of data voltage corresponding to image information and constant reference voltage which does not depend on the image information to the another end of the capacitor, the method comprising: applying the initial voltage to the gate of the transistor by the gate voltage setting circuit, and applying either one voltage of the data voltage corresponding to the image information or the constant reference voltage which does not depend on the image information by the capacitor terminal voltage setting circuit; and switching the one voltage which the capacitor terminal voltage setting circuit has applied, to another voltage of the data voltage corresponding to the image information or the constant reference voltage which does not depend on the image information, with the gate voltage setting circuit not connecting to the gate of the transistor.

According to the present invention, it is possible to increase the maximum luminance of a light emitting element without increasing the voltage output amplitude of a data line which supplies gradation display data, and is possible to suppress the power consumption of a voltage output unit of the data line.

Further features of the present invention will become apparent from the following description of exemplary embodiments with reference to the attached drawings.

### BRIEF DESCRIPTION OF THE DRAWINGS

FIG. 1 is a configuration diagram of a display apparatus according to the present invention.

FIG. 2 is a pixel circuit diagram of Embodiment 1.

FIG. 3 is an explanatory view illustrating an operation of Embodiment 1.

FIG. 4 is a diagram showing a relationship of (data voltage−reference voltage) vs. current in Embodiment 1.

FIG. 5 is a pixel circuit diagram of Embodiment 2.

FIG. 6 is an explanatory view illustrating an operation of Embodiment 2.

FIG. 7 is a pixel circuit diagram of Embodiment 4.

FIG. 8 is a timing chart illustrating an operation of the pixel circuit of Embodiment 4.

### DESCRIPTION OF THE EMBODIMENTS

Exemplary embodiments of the present invention will now be described in detail in accordance with the accompanying drawings.

Hereinafter, the present invention will be described with an organic EL display apparatus using an organic EL element taken as an example. However, the display apparatus according to the present invention is not limited thereto and can be suitably applied to any apparatus capable of controlling the luminescence of a self-luminous element.

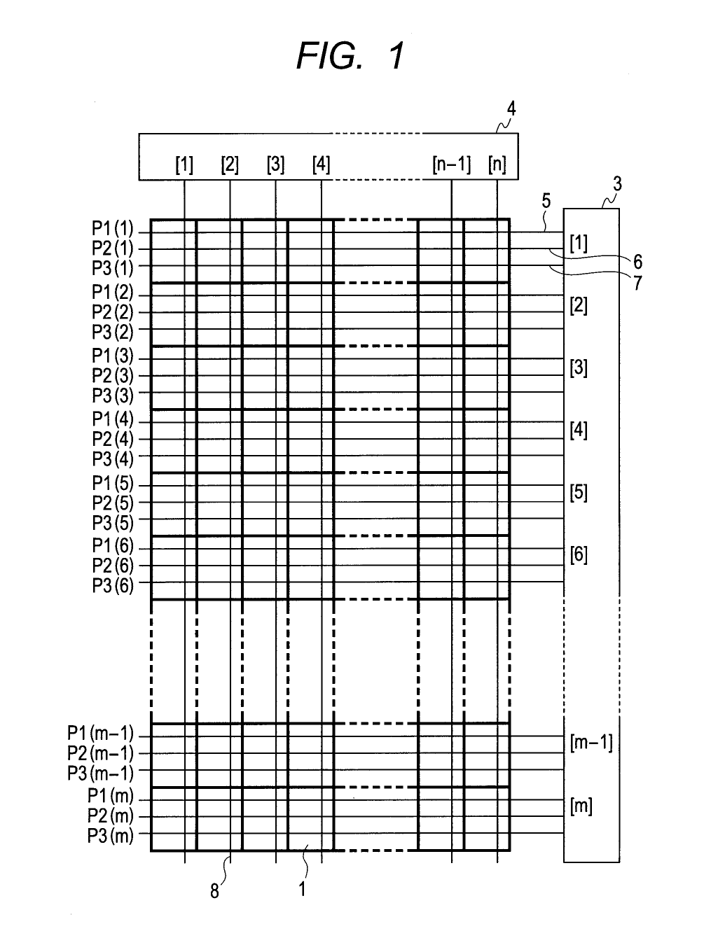

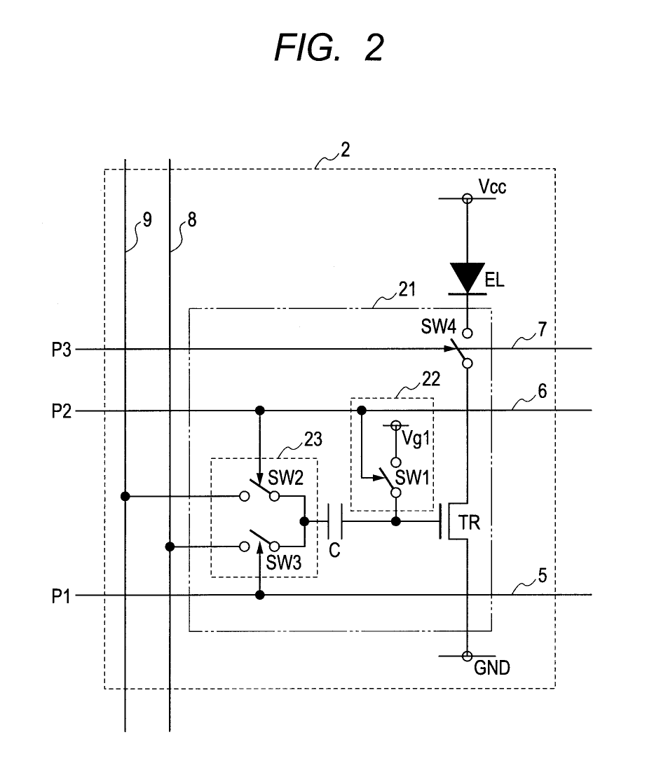

FIG. 1 shows an example of the display apparatus according to the present invention, illustrating an overall configuration of the display apparatus. The display apparatus of FIG. 1 includes an image display unit (hereinafter, also referred to as a “display area”) having pixels 1 two-dimensionally arranged in m rows and n columns (m and n are natural numbers). The pixel 1 includes a number of organic EL elements as many as the number of RGB primary colors, and a pixel circuit 2 (FIG. 2) for supplying a current to the organic EL element. A TFT is used for the pixel circuit 2.

The display apparatus of FIG. 1 includes a row control circuit 3 for controlling the operation of the pixel circuit 2 and a column control circuit 4 for supplying gradation display data corresponding to a video signal to the pixel circuit 2, in the periphery of the display area.

From the row control circuit 3, three control signals P1, P2 and P3 for controlling the operation of the pixel circuit 2 are output for each of the rows 1 to m. The number of control signals is determined according to the configuration of the pixel circuit and is three here, but may be one or two in the specific examples described below.

An image signal corresponding to an image to be displayed is input to the column control circuit 4, and a data voltage Vdata which is gradation display data is output from the column control circuit 4. The output data voltage Vdata is input to the pixel circuit 2 of each column via a data line 8.

Now, a specific example of the pixel circuit is shown to describe the display apparatus according to the present invention and a method of driving the same.

Embodiments of the display apparatus according to the present invention are shown below.

### Embodiment 1

FIG. 2 shows an example of the pixel circuit 2 used in the display apparatus including an organic EL element according to the present invention. The same part as that of FIG. 1 is attached with the same reference numeral.

The pixel circuit 2 includes an organic EL element EL, a current supply circuit unit 21 which supplies a current corresponding to a gradation display signal to the organic EL element EL, and control lines 5 to 7 transferring control signals P1 to P3 to the current supply circuit unit 21. The pixel circuit 2 further includes the data line 8 and a reference voltage line 9 which transfer a data voltage and a reference voltage, respectively, and a power supply wiring Vcc.

The current supply circuit unit 21 includes a drive transistor TR which generates a current corresponding to the gradation display signal, and a capacitor C for holding the gradation display signal and transmitting the gradation display signal to the gate of the drive transistor TR. The current supply circuit unit 21 further includes a gate voltage setting circuit 22 which is connected to the gate of the drive transistor TR, and which is used for setting the gate voltage.

The gate voltage setting circuit 22 sets the gate voltage of the drive transistor TR to an initial value Vg1 while a switch SW1 is turned on by the control signal P2 of the control line 6. The gate voltage setting circuit 22 can cut off the gate of the drive transistor TR by turning off the switch SW1, and places the gate in a high impedance state by cutting off the gate. The gate voltage setting circuit 22 of FIG. 2 includes a constant voltage source Vg1 and the switch SW1. In the next Embodiment 2, the gate voltage setting circuit 22 is used, in which the switch SW1 is such a switch that short-circuits the gate and drain of the drive transistor.

The source of the drive transistor TR is connected to GND, and the drain is connected to the organic EL element EL. In this embodiment, an N-type transistor (hereinafter, referred to as an NMOS) is used as the drive transistor TR. A P-type transistor (hereinafter, referred to as a PMOS) may be also used.

Note that, the source of the transistor is a terminal, wherein a voltage with respect to the gate determines the conduction state of the transistor, while the drain is the terminal opposite to the source. When the drive transistor is an NMOS, the drain is a terminal into which a current flows, while when the drive transistor is a PMOS, the drain is a terminal from which a current flows. When the drive transistor is an NMOS, the drain is connected to the cathode of the organic EL element, while when the drive transistor is a PMOS, the drain is connected to the anode.

The gate of the drive transistor TR is connected to one end of the capacitor C, while switches SW2, SW3 are connected to the other end of the capacitor C, wherein by switching these switches, either one of the reference voltage line 9 and the data line 8 is connected to the other end of the capacitor C. The reference voltage line 9 and the data line 8 are switched by the switches SW2, SW3 to set the voltage of a terminal (hereinafter, referred to as a terminal on the data line side) opposite to the terminal connected to the gate of the capacitor C. The reference voltage line 9, the data line 8, and the changeover switches SW2, SW3 constitute a circuit unit 23 adapted to set the terminal voltage on the data line side of the capacitor C. Hereinafter, the circuit unit 23 is referred to as a capacitor terminal voltage setting circuit 23.

The reference voltage line 9 inputting a reference voltage Vref, the data line 8 inputting a data voltage Vdata, and the control line 5 transferring a control signal P1, which on-off controls the switch SW3 for connecting the data line 8 to the capacitor C, are connected to the current supply circuit unit 21. Furthermore, the control line 6 for transferring the control signal P2 which on-off controls the switch SW1 and the switch SW2 at the same time, the switch SW1 connecting the gate voltage setting circuit 22 to the gate, the switch SW2 connecting the reference voltage line 9 to the capacitor C, is connected to the current supply circuit unit 21. Additionally, a control line 7 for transferring the control signal P3 which controls the switch SW4, the switch SW4 connecting or disconnecting a current supply path for the organic EL element, is connected to the current supply circuit unit 21.

The capacitor terminal voltage setting circuit 23 may include each signal generation circuit (a circuit configured to generate the voltage Vref and provide it to the reference voltage line, the column control circuit 4 configured to generate the data voltage and provide it to the data line, and the like) which is not shown in FIG. 2.

Although the data line 8 and the reference voltage line 9 are separately provided in this embodiment, the two lines may be combined into one wire and the timing may be separated so that the reference signal Vref and the data signal Vdata are applied. In this case, the column control circuit 4 generates also the reference voltage.

In FIG. 2, since the NMOS drive transistor is used, a low-voltage power supply wiring GND is connected to the source of the drive transistor TR and a high-voltage power supply wiring Vcc is connected to the anode of the organic EL element EL. When the drive transistor is a PMOS, the high-voltage power supply wiring is connected to the source of the drive transistor and the low-voltage power supply wiring is connected to the cathode of the organic EL element.

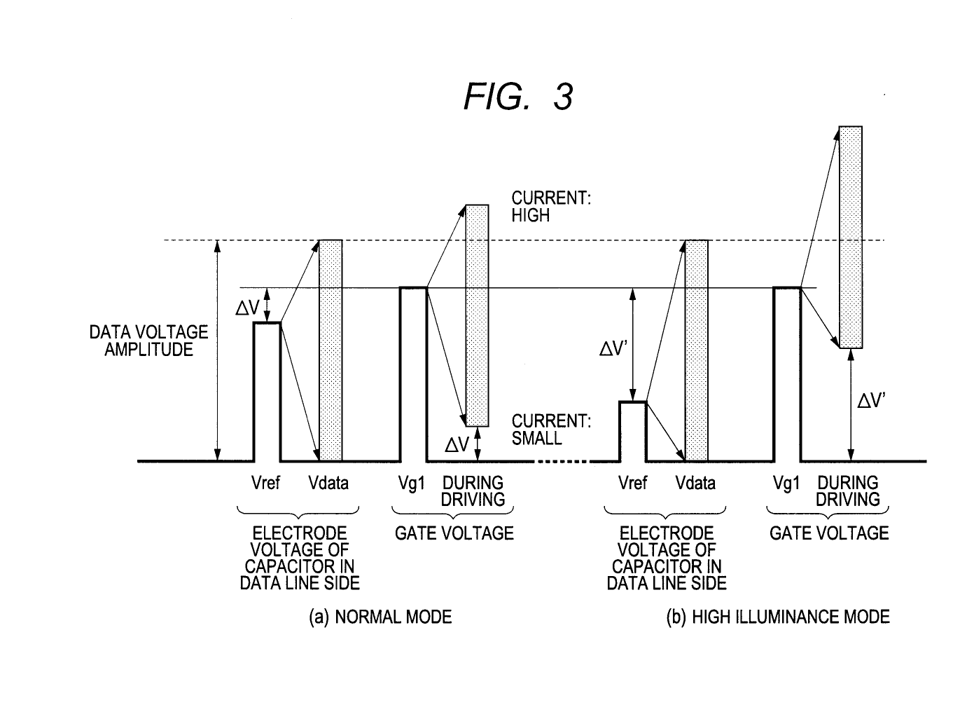

In order to describe the operation of the pixel circuit 2 of FIG. 2, a relationship of the reference voltage Vref, the data voltage Vdata, the gate voltage Vg1 at an initial stage of the drive transistor, and the gate voltage during driving is shown in FIG. 3.

FIG. 3 is a diagram showing initial values (white bar graphs) and subsequent varied values (black (dotted) bar graphs) of the electrical potential of the capacitor terminal on the data line side and the gate electrical potential, respectively, in (a) a normal mode and in (b) a high luminance mode. Hereinafter, the electrical potential of the source of the drive transistor is defined as 0, and the voltage means an electrical potential difference from the source. When the drive transistor is an NMOS, the vertical axis of FIG. 3 represents positive values because the source is at the minimum electrical potential. When the drive transistor is a PMOS, the vertical axis of FIG. 3 represents negative values because the source is at the maximum electrical potential. In the following, a case where the drive transistor is an NMOS is described.

The reference voltage is represented by Vref. The data voltage Vdata is a voltage applied to the data line and is within a certain range as shown in FIG. 3. The data voltage Vdata is a voltage depending on image information to be displayed.

The data voltage Vdata is set within such a voltage range that when the data voltage Vdata is at the minimum, the current supplied to the organic EL element becomes sufficiently low so as to be able to express a black state while when the data voltage Vdata is at the maximum, the current supplied to the organic EL element becomes sufficiently high so as to be able to express a white state. (In the case of a PMOS, the minimum data voltage corresponds to the white state and the maximum data voltage corresponds to the black state.) First, the operation of (a) the normal mode of FIG. 3 is described.

Prior to causing the organic EL element EL to emit light, the initial voltage Vg1 is set to the gate of the drive transistor TR by the gate voltage setting circuit 22.

The initial voltage Vg1 can be set so as to be a gate voltage when the drain current of the drive transistor TR is infinitely close to zero, i.e., the gate voltage (hereinafter, referred to as a threshold voltage Vth) in a boundary where the drive transistor changes from the conduction state to the non-conduction state. This will be described in detail in Embodiment 4 below. Thus, even if the threshold voltage varies from one drive transistor TR to another, a current independent of the variations of the threshold voltage can be supplied to the organic EL element EL. In this case, the gate voltage setting circuit 22 may include a unit adapted to interrupt the current supplied from the drain of the drive transistor TR to the organic EL element EL, and the switch SW1 short-circuiting between the gate and the drain of the drive transistor TR. The gate voltage setting circuit 22 may further include the row control circuit 3 which generates the control signal controlling the make and break of a short-circuit switch.

However, in the present invention, the initial voltage Vg1 set to the gate does not necessarily need to be the threshold voltage but may be any configurable voltage, such as the voltage Vcc of the high-voltage power supply wiring, the voltage GND of the low-voltage power supply wiring, or a certain voltage other than the above-described voltages. Moreover, in setting the initial voltage Vg1, the current from the drive transistor TR to the organic EL element EL does not always need to be interrupted.

While the gate initial voltage Vg1 is set by turning on SW1, the switch SW2 of the capacitor terminal voltage setting circuit 23 is also turned on (SW3 is turned off) to set the terminal on the data line side of the capacitor C to the reference voltage Vref. As a result, a voltage between both terminals of the capacitor C is set to Vg1−Vref.

After the gate initial voltage Vg1 and the terminal voltage Vref on the data line side of the capacitor C have been set, respectively, the switch SW1 of the gate voltage setting circuit 22 is turned off. The gate of the drive transistor TR becomes in a high impedance state, where the gate voltage can be varied. Moreover, since there is no flowing in and out of electric charges for the capacitor C1, the voltage between the terminals is fixed to Vg1−Vref. In FIG. 3, this voltage is represented by ΔV.

Subsequently, the switch SW2 of the capacitor terminal voltage setting circuit 23 is turned on and SW3 is turned off to connect the terminal on the data line side of the capacitor C to the data line 8 side and set the same to the data voltage Vdata. In FIG. 3, this switching operation is indicated by one-sided arrows.

Because the terminal voltage on the data line side of the capacitor C changes from Vref to Vdata, the terminal voltage on the gate side of the capacitor C, i.e., the gate voltage of the drive transistor TR, also changes. Since the voltage between both terminals of the capacitor C is fixed to Vg1−Vref, the gate voltage follows a change in the voltage of the electrode on the data line side of the capacitor C and becomes Vg1−Vref+Vdata.

After the gate voltage changes as described above, the control signal moves to other pixel circuit and controls the same, and both of the switch of the gate voltage setting circuit 22 and the switch of the capacitor terminal voltage setting circuit 23 are turned off. The gate-to-source voltage Vg1−Vref+Vdata (hereinafter, referred to as the write voltage) of the drive transistor TR, which is finally determined in the above-described operation, is held in the capacitor C, and in the subsequent light emission period a driving current corresponding to this voltage is supplied to the organic EL element EL.

Next, the high luminance mode is described.

FIG. 3(b) shows the setting voltage and the operating voltage in the high luminance mode. As shown in FIG. 3(b), when the luminance level of the organic EL element is increased, i.e., when the high luminance mode is selected, the reference voltage Vref is set lower than that in the normal mode.

Since the reference voltage is lower than that in the normal mode, either of when the data voltage is the maximum voltage and when the data voltage is the minimum voltage the write voltage Vg1−Vref+Vdata of the gate becomes higher than that in the normal mode. Therefore, although the data voltage range is the same as that in the normal mode, the current amount supplied to the organic EL element becomes higher than that in the normal mode.

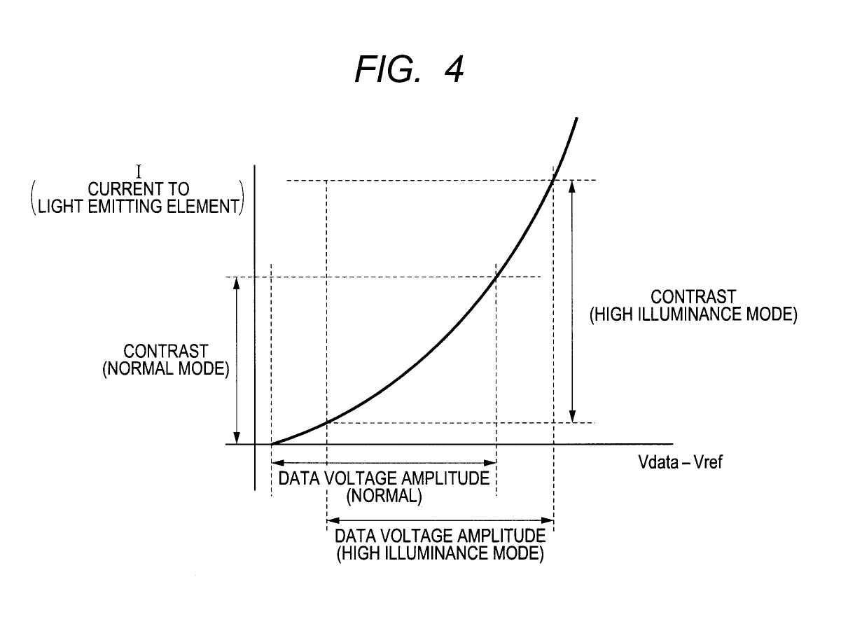

FIG. 4 is a diagram showing an example of a relationship between the voltage of a portion Vdata−Vref of the write voltage, the portion Vdata−Vref determining the supply current, and a current I supplied to the organic EL element, in the current supply circuit unit 21 of the pixel circuit 2. The former is nothing else but a voltage difference Vdata−Vref in the voltages supplied by the reference voltage line 9 and the data line 8, respectively. The range of this voltage differs by a difference in the reference voltages between the normal mode and the high luminance mode. The range of the amplitude of the data voltage is the same in the normal mode and in the high luminance mode. As apparent from FIG. 4, in the high luminance mode, the range of the amplitude of the data voltage shifts so that the current in the entire operating range increases as compared with that in the normal mode.

The luminances of the organic EL element in the normal mode and in the high luminance mode satisfy the following relationships: (current flowing through the organic EL element when the gradation display data is at the maximum level in the high luminance mode)>(current flowing through the organic EL element when the gradation display data is at the maximum level in the normal mode); and (current flowing through the organic EL element when the gradation display data is at the minimum level in the high luminance mode)>(current flowing through the organic EL element when the gradation display data is at the minimum level in the normal mode).

Accordingly, the ratio of the luminance when the gradation display data is at the maximum level to the luminance when the gradation display data is at the minimum level in the normal mode is larger than the ratio of the luminance when the gradation display data is at the maximum level to the luminance when the gradation display data is at the minimum level in the high luminance mode. That is, in the high luminance mode, the contrast becomes low while the luminance increases as a whole.

Although in FIG. 3 and FIG. 4, two types: the high luminance mode and the normal mode, are taken as an example, an intermediate luminance adjustment is also possible by continuously changing the reference voltage, other than the high luminance mode and the normal mode.

The contrast (the luminance ratio of the maximum luminance to the minimum luminance) of the organic EL element by which excellent display is obtained is preferably not less than 500.

Preferably, the reference voltage may be set within a range from the minimum value to the maximum value of the data voltage. This is because when the data voltage and the reference voltage are output from the same data voltage output unit, an effect of the present invention, i.e., the effect of suppressing the power consumption of the data voltage output unit without increasing the voltage amplitude in the data voltage output unit, is more effectively obtained.

Switching between the normal mode and the high luminance mode can be selected by a user of the display apparatus. If a high luminance mode changeover switch is provided in one area of the display apparatus and a user switches this switch to the high luminance mode, a controller (not shown) of the display apparatus or the column control circuit 4 adjusts the reference voltage Vref to the lower reference voltage Vref and outputs this reference voltage Vref to the reference voltage line 9.

When the drive transistor is a PMOS, the configuration is the same as that in the case of an NMOS except that the high-voltage power supply wiring and the connection between the organic EL element and the drive transistor are reversed from those of FIG. 2.

As described above, the normal mode and the high luminance mode are switched by changing the reference voltage Vref without changing the amplitude of the data voltage Vdata. In the high luminance mode, although not only the maximum luminance but the minimum luminance increases, this will not cause a problem within a display range in which the contrast is excellent. Because the output amplitude of a data voltage generating circuit (not shown) inside the column control circuit 4 does not need to be increased, the power consumption can be suppressed. Because a process for obtaining an ordinary circuit with a low breakdown voltage can be used, an increase in the manufacturing cost can be prevented.

### Embodiment 2

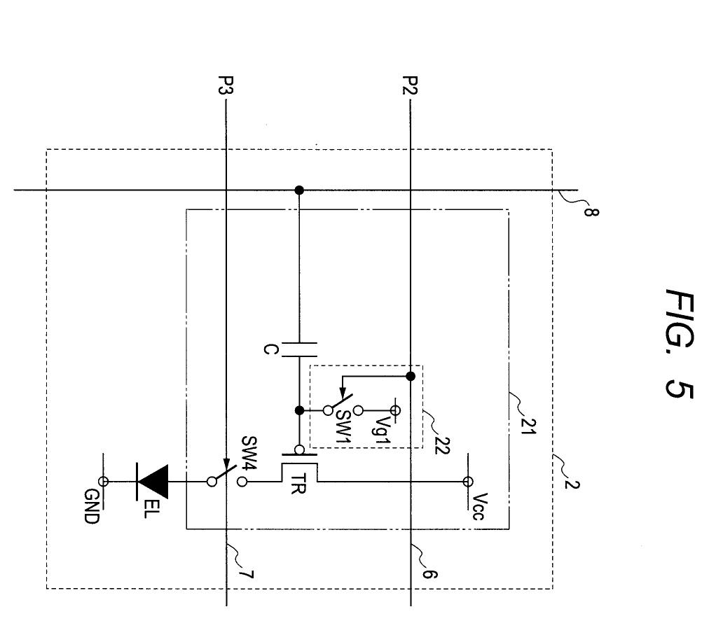

FIG. 5 shows another example of the pixel circuit of the display apparatus according to the present invention, wherein the reference voltage line 9 and the data line 8 in the pixel circuit 2 of FIG. 2 are combined into one wiring 8. The capacitor C is connected between the gate of the drive transistor TR and the data line 8. In the circuit of FIG. 5, the control signal P1 and the switches SW2 and SW3 are not provided. In this case, the capacitor terminal voltage setting circuit 23 includes a connection wire connecting the capacitor C and the data line 8, the data line 8, and a circuit (column control circuit 4 of FIG. 1) for supplying the data voltage and the reference voltage to the data line 8.

In this embodiment, although a PMOS is used as the drive transistor, an NMOS may be also used. Other element having the same function as that in the pixel circuit 2 of FIG. 2 is given the same reference symbol.

There are two control lines: the control line 6 transferring the control signal P2 which controls the switch SW1 of the gate voltage setting circuit 22; and the control line 7 transferring the control signal P3 of the switch SW4 which interrupts the current flowing through the EL.

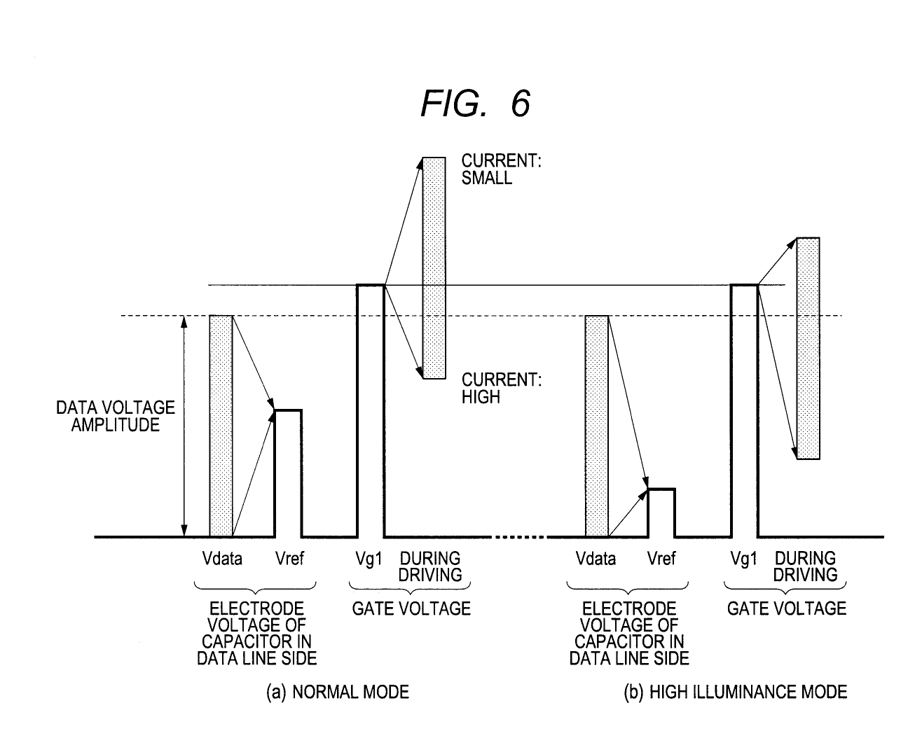

The operation of the pixel circuit 2 of FIG. 5 is described using FIG. 6 similar to FIG. 3. In the pixel circuit 2 of FIG. 5, a PMOS is used for the drive transistor TR. The source of the drive transistor TR is connected to Vcc and the cathode of the organic EL element EL is connected to GND. Since the voltage is measured with the source electrical potential Vcc as a reference, the vertical axis of FIG. 6 represents negative electrical potential, wherein the lower the gate electrical potential, the deeper the conduction state of the PMOS transistor becomes.

First, an arbitrary initial voltage Vg1 is set to the gate of the drive transistor TR by the gate voltage setting circuit 22. The initial voltage Vg1 can be set to the threshold voltage of the drive transistor TR in advance. In that case, the gate voltage setting circuit 22 includes the switch SW1 which short-circuits the gate and drain of the drive transistor, and SW4 which interrupts between the drain and the organic EL element.

The initial voltage Vg1 may however be a voltage other than Vg1, and may be the voltage Vcc of the high-voltage power supply wiring or the voltage GND of the low-voltage power supply wiring.

In this embodiment, the setting sequence of the reference voltage and the data voltage is reversed from that of the previous embodiment. That is, while the switch SW1 of the gate voltage setting circuit 22 is turned on for each row by the control line P2 and the initial voltage Vg1 of the gate is set, the data voltage Vdata is set to the electrode on the data line side of the capacitor C.

This setting is performed across all rows. In the meantime, SW4 is off. Moreover, while one row is selected, SW1 of other row is off. Although the data line voltage varies with the data voltage of each row, the voltage between the terminals of the capacitor C is held.

After the initial voltage Vg1 and the capacitor terminal voltage Vdata of the pixel circuit 2 for all rows have been set, SW4 is turned on and the voltage of the data line is switched to the reference voltage Vref by the column control circuit 4. Thus, the gate voltage of the drive transistor TR becomes Vg1−Vdata+Vref, and a corresponding driving current is supplied to the organic EL element EL.

When the organic EL element EL is operated in the high luminance mode, as shown in FIG. 6(b), the reference voltage Vref is set lower than that in the normal mode, with the data voltage Vdata remained as it is. Either of when the data voltage is the maximum voltage and when the data voltage is the minimum voltage, the voltage Vdata−Vref between the terminals of the capacitor C is larger than that in the normal and therefore the voltage of Vg1−Vdata+Vref becomes lower than that in the normal mode, resulting in an increase of the current amount supplied to the organic EL element EL. As with Embodiment 1, in the high luminance mode, the range of the amplitude of the data voltage shifts so that the current in the entire operating range increases as compared with that in the normal mode.

As described above, also in this embodiment using the pixel circuit of FIG. 5, it is possible to increase the maximum luminance without increasing the output voltage amplitude in the voltage output unit of the data line and also possible to suppress the power consumption of the voltage output unit of the data line. Moreover, according to this embodiment, not only the above-described effect but the same effect as that of Embodiment 1 can be obtained.

### Embodiment 3

A display amount detection unit adapted to detect the overall brightness of a display image can be provided in the display apparatus of FIG. 1. This embodiment provides a system which determines the reference voltage according to a result detected by the display amount detection unit.

The display amount as an indicator indicative of the overall brightness of a display image is defined as a sum of the gradation display data of all pixels, with the brightness when all pixels display 100% white as the reference brightness. When all pixels are displayed at 50% brightness, the display amount is 0.5. Also when a half of the pixels are displayed at 100% brightness and the other half pixels are displayed at 0% brightness, the display amount is 0.5. The display amount may be reworded as the average luminance. Since the display amount can be calculated from image display data, the display amount detection unit can be provided in the inside of the column control circuit 4 or in the inside of a controller (not shown) which sends an image signal to the column control circuit 4. The pixel circuit may be either of the pixel circuit of Embodiment 1 and the pixel circuit of Embodiment 2.

In this embodiment, when the display amount is not more than a certain value, the pixel circuit is controlled so as to display in the high luminance mode. Specifically, the reference voltage is set so that the maximum luminance of a pixel doubles when the display amount is not more than 0.5. Furthermore, the reference voltage is set so that the maximum luminance of a pixel quadruples when the display amount is not more than 0.25. If the reference voltage is controlled in this manner, then even in the high luminance mode, the total current amount flowing into the display area is similar to that in the normal mode. Accordingly, when an upper limit of a total current amount is determined in the normal mode, a current exceeding the upper limit will not flow even in the high luminance mode. By setting in this manner, a component with a high rated current does not need to be used in the power supply unit, resulting in a reduction in cost. Furthermore, since a drop in the power-supply voltage due to a wiring resistance does not exceed that in the normal mode, an extra margin does not need to be taken into consideration.

Here, the detection of the display amount displayed on the display screen is preferably calculated after a sum of the gradation display data after white balance processing of all pixels is calculated using the gradation display data after subjecting the gradation display data to white balance processing. In this case, the display amount may be detected using all Bits of the gradation display data after white balance processing, or the display amount may be detected using N-Bits (N is an integer) from the highest order of the gradation display data after white balance processing, in order to reduce the calculation amount.

The detection of the display amount is preferably calculated using the gradation display data after gamma conversion processing of the gradation display data. Alternatively, a value, which is obtained by multiplying the data prior to gamma conversion processing by a coefficient of the gamma conversion processing, may be used.

As described above, according to the present invention, the peak luminance of the organic EL element of the display apparatus can be easily controlled by changing the reference voltage when the gradation display data is written in a pixel. In this case, the reference voltage is within a range of voltage amplitudes of the gradation display data, and therefore, even when the peak luminance is increased, the output voltage amplitude of the voltage output unit of the data line can be suppressed, resulting in a reduction in the power consumption of the voltage output unit on the data line. Moreover, according to this embodiment, not only the above-described effect but the same effect as that of Embodiment 1 can be obtained.

### Embodiment 4

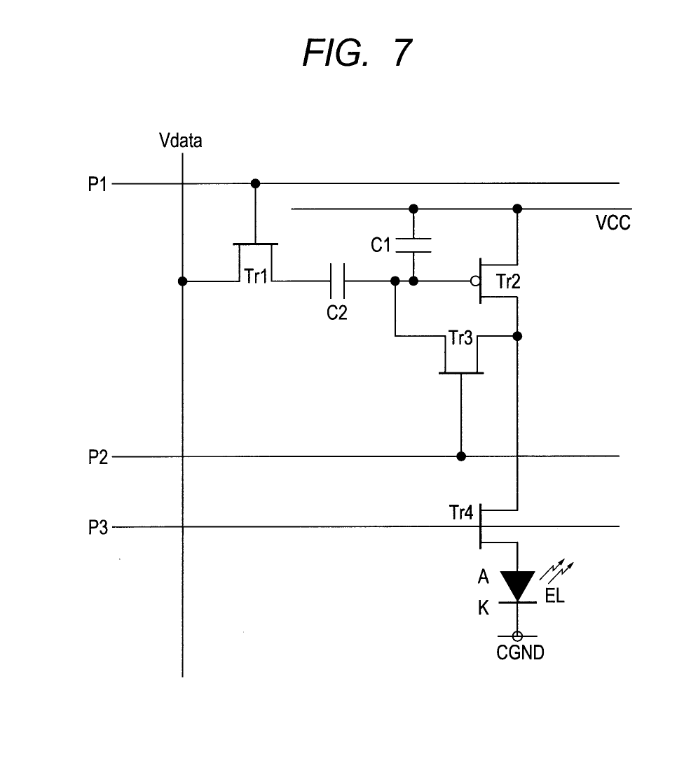

FIG. 7 shows an example of a pixel circuit including the organic EL element which is suitably used in the display apparatus according to the present invention, such as the display apparatus of FIG. 1.

A control line transmitting the control signal P1 is connected to the gate of a transistor Tr1, and a data line supplying the data voltage Vdata is connected to the source of the transistor Tr1. A control line transmitting the control signal P2 which determines an auto zero period is connected to the gate of a transistor Tr3, and a control line transmitting the control signal P3 which controls a light emission period is connected to the gate of a transistor Tr4. A +VCC wiring is connected to the source of a drive transistor Tr2 and one terminal of a capacitor C1. The anode of the organic EL element is connected to the drain of the transistor Tr4, and the cathode of the organic EL is connected to a CGND wiring. The source of the transistor Tr4 is connected to the drain of the drive transistor Tr2 and the drain of the transistor Tr3. The drain of the transistor Tr1 is connected to one terminal of a capacitor C2, and the other terminal of the capacitor C2 is connected to the gate of the drive transistor Tr2, the source of the transistor Tr3, and one terminal of the capacitor C1, the one terminal not being connected to Vcc.

In FIG. 7, the pixel circuit includes three NMOS transistors (Tr1, Tr3, Tr4), a PMOS transistor (Tr2) which is the drive transistor, two capacitors C1 and C2, the organic EL element (EL), the data line, and the control lines (P1, P2, P3). Furthermore, the pixel circuit includes the +VCC wiring and the GND wiring.

In FIG. 7, the data line supplying the data voltage Vdata is a reference voltage line/data line which also acts as the reference voltage line supplying the reference voltage. Note that the reference voltage line and the data line may be separate wirings.

The capacitor C1 is a hold capacitor for holding the signal voltage of the data line, and the capacitor C2 is a coupling capacitor for transferring the voltage signal of the data line to the capacitor C1 and the gate of the drive transistor Tr2.

The drive transistor Tr2 is a drive transistor supplying a current to the organic EL element. In FIG. 7, a PMOS is used as the drive transistor Tr2.

The transistor Tr1 functions as a switch which connects between the data line and the electrode on the data line side of the capacitor C2. The transistor Tr3 is a switch which short-circuits between the drain and the gate of the drive transistor Tr2, and the transistor Tr4 is a switch interrupting the path of a current flowing from the drive transistor Tr2 to the organic EL element EL.

The control signals P1 to P3 control the operations of three NMOS switching transistors Tr1, Tr3 and Tr4.

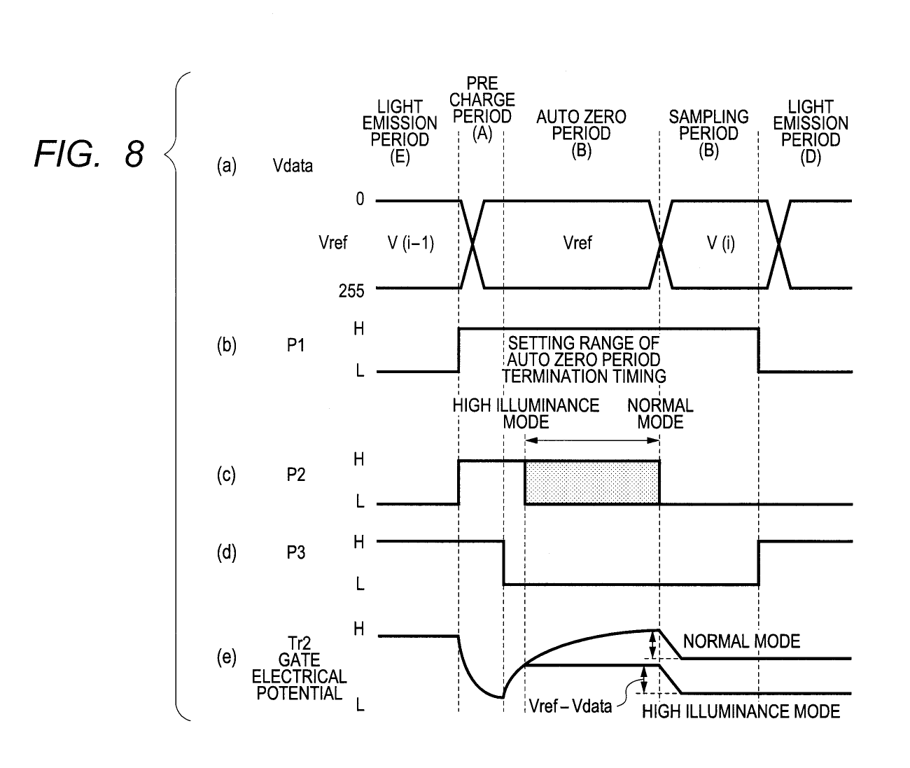

FIG. 8 is a timing chart showing the operation of the pixel circuit of FIG. 7.

As shown in the timing chart of FIG. 8, the circuit of FIG. 7 has four periods: (A) pre charge period, (B) auto zero period, (C) sampling period, and (D) light emission period, for one row (i-th row, here).

First, in the pre charge period of (A), all P1 to P3 are set to H (High). During this period, all of the switching transistors Tr1, Tr3 and Tr4 are turned on, and a current flows through the organic EL element EL with the drive transistor Tr2 diode-connected. Moreover, the reference voltage Vref is applied to the data line. As a result, the gate voltage of Tr2 is reset to a low level.

During the auto zero period of (B), since Tr4 is turned off, the drain current of Tr2 discharges the electric charges of C1 and C2 through Tr3. As discharging proceeds, the gate electrical potential of Tr2 rises, and Tr2 becomes in a non-conduction state after a sufficiently long time. The gate of Tr2 at this time becomes an electrical potential lower than Vcc by the threshold voltage Vth.

During the sampling period of (C), Tr3 is turned off and a data voltage V(i) is applied to the data line. The voltage difference between Vref and V(i) drops the gate electrical potential of Tr2 at a ratio corresponding to the ratio of the capacitors C1 and C2, and Tr2 becomes in a conduction state at a depth corresponding to the dropped electrical potential. At the end of the sampling period, Tr1 is turned off and the gate voltage of Tr2 in this conduction state will be held as the voltage between the terminals of C2.

During the period of (D), Tr4 is turned on, and according to the conduction state of Tr2 held in C2, a current flows from Tr2 to the organic EL element EL and the organic EL element EL emits light.

Tr3 and Tr4, since having a function to set the gate initial voltage of the drive transistor Tr2 in this manner, constitute the gate voltage setting circuit 22 of Embodiment 1. The gate voltage setting circuit 22 may be considered to include the control lines P2 and P3 controlling these switches, and a circuit (the row control circuit 3 of FIG. 1) sending a control signal to these control lines P2 and P3, as well. Moreover, the gate initial voltage Vg1 to be set is Vcc−Vth, in this case.

Moreover, the transistor Tr1, the data line 8, and the column control circuit of FIG. 1 constitute the capacitor terminal voltage setting circuit 23.

In this embodiment, by shortening the auto zero period as shown in FIG. 8(c), the auto zero period is terminated before the gate electrical potential converges to Vcc−Vth. In the normal mode, the auto zero period is maintained until the gate electrical potential converges to Vcc−Vth or until the gate electrical potential reaches a value close to this electrical potential. In the high luminance mode, since the auto zero period is shorter than that in the normal mode, the gate electrical potential remains at an electrical potential lower than Vcc−Vth.

If the gate initial voltage is low, the gate voltage after the sampling period drops accordingly. Hence, a change in the gate initial voltage causes the same effect as that by a change in the reference voltage. That is, if the gate initial voltage drops, then the gate voltage determined according to the data also shifts to a lower level as a whole and therefore the same effect as that when Vref is reduced occurs, thus realizing the high luminance mode.

A function to adjust the auto zero period is provided in a controller (not shown) or in the row control circuit 3 of the display apparatus. If a user of the display apparatus sets the changeover switch to the high luminance mode side, this signal is sent to the controller or the row control circuit 3 to reduce the pulse width of the control signal P2.

Change of the length of the auto zero period and change of the reference voltage are independent from each other, and each one of these adjustments can produce the high luminance mode. However, by changing the length of the auto zero period and changing the reference voltage, it is also possible to obtain an increased effect of a higher maximum luminance.

According to this embodiment, the luminance of an organic EL element can be easily controlled by changing the auto zero period. Neither data voltage nor reference voltage needs to be modified.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-154728, filed on Jun. 30, 2009, which is hereby incorporated by reference herein in its entirety.

What is claimed is:

1. A display apparatus comprising:
a plurality of pixels arranged two-dimensionally, wherein each of the pixels has a light emitting element, a transistor which controls a current supplied to the light emitting element, and a capacitor of which one end is connected to a gate of the transistor;
a gate voltage setting circuit capable to connect to the gate of the transistor, the gate voltage setting circuit applying an initial voltage to the gate of the transistor in connecting;
a capacitor terminal voltage setting circuit which is connected to another end of the capacitor, and which applies any of data voltage corresponding to image information and constant reference voltage which does not depend on the image information to the another end of the capacitor; and
a control circuit which controls the gate voltage setting circuit and the capacitor terminal voltage setting circuit,
wherein the control circuit applies the initial voltage to the gate of the transistor by the gate voltage setting circuit, and applies either one voltage of the data voltage corresponding to the image information or the constant reference voltage which does not depend on the image information by the capacitor terminal voltage setting circuit, and then switches the one voltage which the capacitor terminal voltage setting circuit has applied, to another voltage of the data voltage corresponding to the image information or the constant reference voltage which does not depend on the image information, with the gate voltage setting circuit not connecting to the gate of the transistor.

2. A display apparatus according to claim 1, wherein the gate voltage setting circuit includes a unit for interrupting a current supplied from a drain of the transistor to the light emitting element, and a short-circuit switch which shorts between the gate and the drain of the transistor.

3. A display apparatus according to claim 2, wherein the gate voltage setting circuit is configured so that the initial voltage is changed by changing timing at which short-circuit between the gate and the drain by short-circuit switch is ended.

4. A display apparatus according to claim 1, wherein the capacitor terminal voltage setting circuit is configured so that the reference voltage can be changed.

5. A method of driving a display apparatus,
The display apparatus comprising:
a plurality of pixels arranged two-dimensionally, wherein each of the pixels has a light emitting element, a transistor which controls a current supplied to the light emitting element, and a capacitor of which one end is connected to a gate of the transistor;
a gate voltage setting circuit capable to connect to the gate of the transistor, the gate voltage setting circuit applying an initial voltage to the gate of the transistor in connecting; and
a capacitor terminal voltage setting circuit which is connected to another end of the capacitor, and which applies any of data voltage corresponding to image information and constant reference voltage which does not depend on the image information to the another end of the capacitor, and
the method comprising:
applying the initial voltage to the gate of the transistor by the gate voltage setting circuit, and applying either one voltage of the data voltage corresponding to the image information or the constant reference voltage which does not depend on the image information by the capacitor terminal voltage setting circuit; and
switching the one voltage which the capacitor terminal voltage setting circuit has applied, to another voltage of the data voltage corresponding to the image information or the constant reference voltage which does not depend on the image information, with the gate voltage setting circuit not connecting to the gate of the transistor.
